(19) United States
(12) Patent Application Publication
(10) Pub. No.: US 2006/0138762 A1
(43) Pub. Date: Jun. 29, 2006

(54) Method and system for folding airbags

(75) Inventor: Jin-soo Jang, Shiga (JP)

Correspondence Address: FOLEY AND LARDNER LLP;SUITE 500, 3000 K STREET NW, WASHINGTON, DC, 20007, US

(73) Assignee: TAKATA CORPORATION

(21) Appl. No.: 11/315,132

(22) Filed: Dec. 23, 2005

Related U.S. Application Data
(60) Provisional application No. 60/639,325, filed on Dec. 28, 2004.

(51) Int. Cl. B60R 21/237; B65B 63/04; B31B 1/52

(52) U.S. Cl. 280/743.1; 53/429; 493/457

(57) ABSTRACT

Systems and methods for folding airbags are disclosed. An airbag folding body includes a cavity having a rear wall and a top wall, the rear wall being opposite an entrance of an airbag cushion. The airbag folding body also includes a notch formed at an intersection of the top wall and the rear wall, the notch being adapted to capture, engage or secure a leading edge of the airbag cushion. The rear wall is adapted to direct the leading edge of the airbag toward the notch.

### CROSS-REFERENCE

This application claims the benefit under 35 U.S.C. 119(e) of U.S. Patent Application No. 60/639,325, filed Dec. 28, 2004, which is incorporated herein by reference in its entirety.

### BACKGROUND

The present invention relates generally to the field of safety restraint systems. In particular, the invention relates to methods and systems for folding airbags for use as, for example, side air-bag curtains.

### SUMMARY

According to an embodiment of the present invention, an airbag folding body includes a cavity having a rear wall and a top wall, the rear wall being opposite an entrance of an airbag cushion. The airbag folding body also includes a notch formed at an intersection of the top wall and the rear wall, the notch being adapted to capture, engage or secure a leading edge of the airbag cushion. The rear wall is adapted to direct the leading edge of the airbag cushion toward the notch.

In another embodiment of the invention, a method of folding an airbag includes causing relative movement of an airbag cushion toward a folding body, the folding body having a cavity with a rear wall and a top wall, and directing a leading edge of the airbag cushion toward a notch formed at an intersection of the top wall and the rear wall of the folding body, the notch being adapted to capture, engage or secure the leading edge.

According to another embodiment of the invention, an airbag folding arrangement includes a first comb portion having two or more folding regions, the folding regions being separated by stationary blades, and a fastener for securing an end of an airbag cushion. The arrangement also includes a second comb portion having one or more movable blades adapted to translate at least partially into the folding regions, thereby forming a fold of an airbag cushion positioned between the first comb portion and the second comb portion.

In another embodiment, an airbag folding method includes positioning an airbag cushion between a first comb portion and a second comb portion, the first comb portion having two or more folding regions, the folding regions being separated by stationary blades, the second comb portion having one or more movable blades positioned above corresponding folding regions and being adapted to translate at least partially into the folding regions; securing one end of the airbag cushion on one side of the folding regions; and translating the movable blades sequentially into the folding regions proceeding from a folding region closest to the secured end of the airbag cushion to a folding region further from the secured end of the airbag cushion.

It is to be understood that both the foregoing general description and the following detailed description are exemplary and exemplary only, and are not restrictive of the invention as claimed.

### BRIEF DESCRIPTION OF THE DRAWINGS

These and other features, aspects, and advantages of the present invention will become apparent from the following description, appended claims, and the accompanying exemplary embodiments shown in the drawings, which are briefly described below.

FIG. 1 is a perspective illustration of an airbag folding arrangement according to an embodiment of the invention;

FIGS. 2A and 2B are cross-sectional views taken along II-II of embodiments of the airbag folding arrangement of FIG. 1 illustrating a folding process;

FIG. 3 is a cross-sectional illustration of an airbag folding arrangement according to another embodiment of the invention; and

FIG. 4 illustrates an airbag folding process using the airbag folding arrangement of FIG. 3.

### DETAILED DESCRIPTION

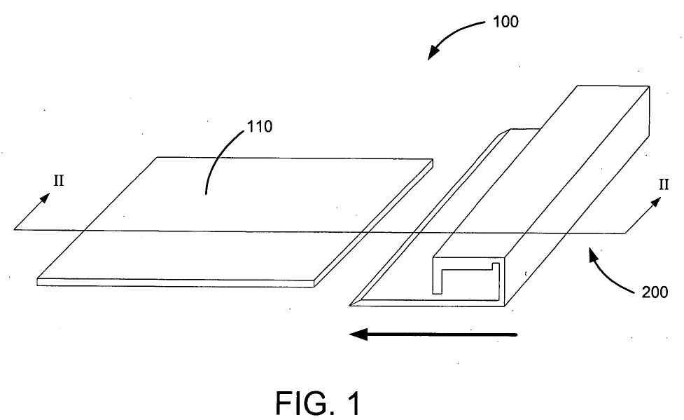

Referring to FIG. 1, an embodiment of an airbag folding arrangement is illustrated. The airbag folding arrangement 100 is adapted to fold an airbag 110 into a folded configuration for stowing of the un-inflated airbag. Such folding arrangements may be useful for airbags used for airbag curtains for side-impact protection, for example. The dimensions of the cushion 110 may be selected according to the desired use.

As shown in FIG. 1, the airbag folding arrangement 100 includes a folding body or push-in scoop 200. As indicated by the arrow, the folding body 200 is adapted to be moved toward the airbag 110. The movement of the folding body 200 may be achieved by a mechanism (not shown) for pushing the entire body toward the airbag 110. In other embodiments, the folding body 200 may be stationary, while a conveyor (or other moving mechanism) may be provided to move the airbag 110. The speed of the movement of the airbag 110 and the folding body relative to each other may be determined according to certain factors such as, for example, the dimension and material of the airbag 110.

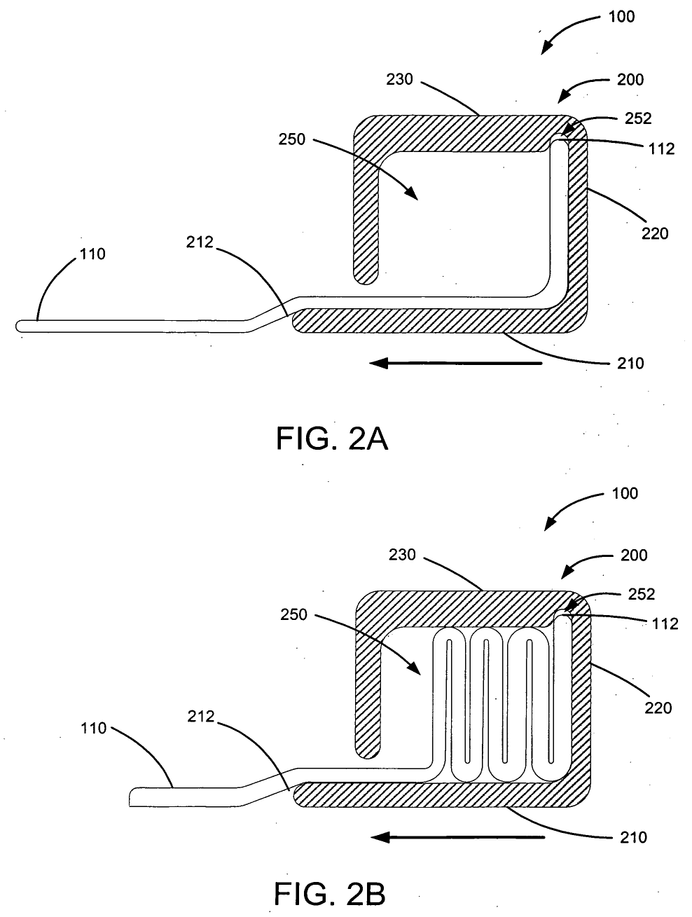

FIGS. 2A and 2B illustrate the folding body 200 and the use of the folding arrangement 100 of FIG. 1 in greater detail. The folding body 200 includes a bottom wall 210, a rear wall 220 and a top wall 230 forming a cavity 250. The dimensions of the cavity 250 and the surrounding walls 210, 220, 230 may be selected to produce the desired dimensions of the folded airbag. The bottom wall 210 may include a ramp 212 formed at the leading edge to facilitate the direction of the airbag 110 into the cavity 250 as the airbag 110 and the folding body 200 are moved relative to each other. The ramp 212 allows the airbag 110 to be essentially scooped into the cavity 250. The lower end of the rear wall 220 is provided with a rounded transition to the bottom wall 210 to facilitate routing of the airbag fabric. As the airbag 110 and the folding body 200 are moved relative to each other, the leading edge 112 of the airbag 110 is directed upward and into the cavity 250.

As shown in FIGS. 1, 2A and 2B, the rear wall 220 is substantially perpendicular to the bottom wall 210. In certain embodiments, the rear wall may be slightly tilted so that the angle between the bottom wall 210 and the rear wall 220 is slightly greater than 90 degrees. For example, the angle between the bottom wall 210 and the rear wall 220 may be between 90 and 100 degrees. The angle may also be greater than 100 degrees up to 120 degrees. The rear wall 220 causes the leading edge 112 of the airbag 110 to turn upward as the airbag 110 and the folding body 200 are moved relative to each other.

The top wall 230 is substantially parallel to the bottom wall 210 and forms an upper barrier for the folded airbag. Thus, the distance between the bottom wall 210 and the top wall 230 determines the maximum length of each fold of the folded airbag.

A notch 252 is formed in the cavity at the corner of the rear wall 220 and the top wall 230. The notch 252 is formed to capture, engage or secure the leading edge 112 of the airbag 110, as illustrated in FIG. 2A, as the leading edge 112 travels along the rear wall 220. As shown in FIG. 2A, notch 252 is formed so as to prevent the movement of the leading edge 112 of the airbag cushion beyond the corner of the rear wall 220 and the top wall 230. The scope of the present invention includes other alternative features that may be provided within the cavity to capture, engage or secure the leading edge 112 of the airbag cushion, and is not limited to the notch 252.

With the leading edge 112 of the airbag 110 secured in the notch 252, the airbag 110 begins folding with continued relative movement between the airbag 110 and the folding body 200, as shown in FIG. 2B. The continued relative movement between the airbag 110 and the folding body 200 causes the airbag 110 to continue entry into the cavity 250 via the ramp 212. The airbag 110 is forced up and down to form folds within the cavity 250. Thus, a simple relative movement of the folding body 200 and the airbag 110 results in the desired folding of the airbag 110.

The size of the cavity 250 may be adapted for the size of the folds as well as the number of folds. Further, different sections of an airbag may be processed sequentially to fold a large airbag cushion.

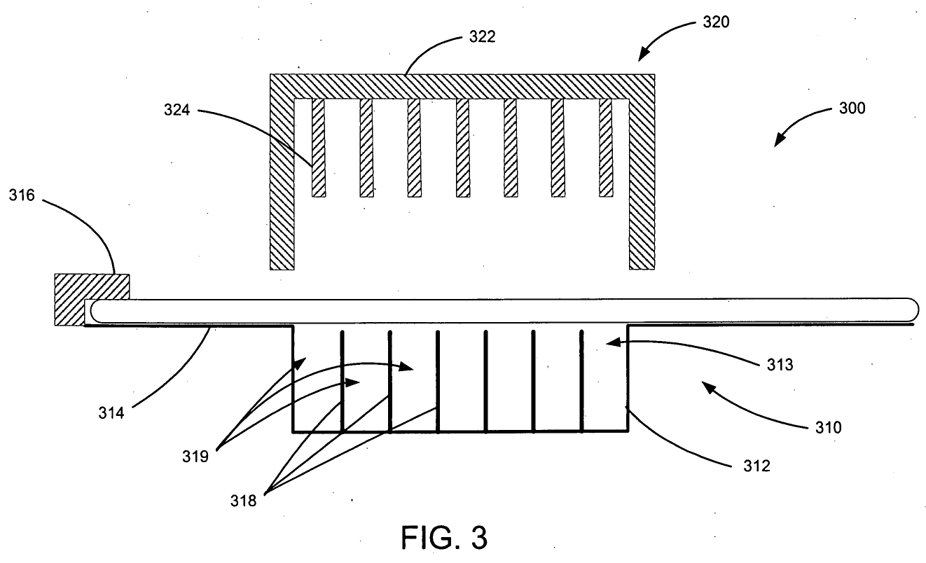

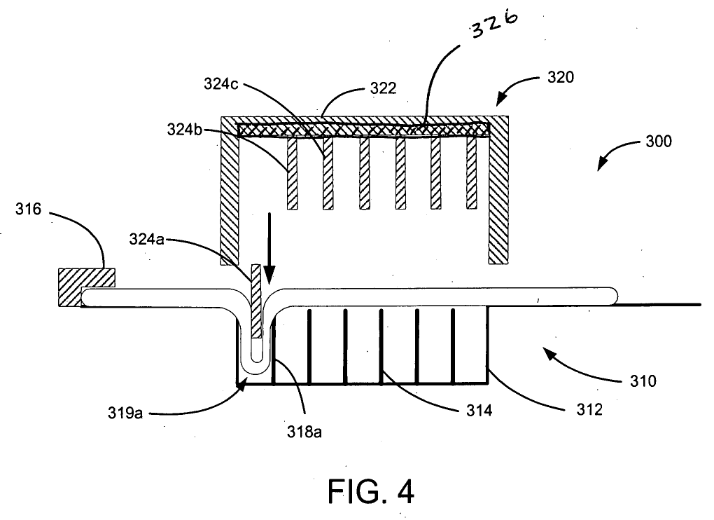

FIGS. 3 and 4 illustrate another embodiment of an airbag folding arrangement according to the invention. The arrangement 300 includes a lower comb body 310 and an upper comb body 320. The lower comb body 310 is formed of a rigid stationary structure which includes a housing 312 having a cavity 313. Support surfaces 314 are formed on each side of the cavity 313 to support the airbag 110. One end of the airbag 110 is secured to the supporting surface 314 via a clamp or chuck 316. Of course, numerous other alternative configurations may be provided to secure the airbag 110.

A plurality of comb blades 318 are provided within the cavity 313. The comb blades 318 may be rigid structures affixed within the cavity extending substantially vertically from the housing 312. The comb blades 318 are equally spaced apart, forming fold regions 319 therebetween.

The upper comb body 320 includes a stationary housing 322 positioned substantially above the cavity 313 of the lower comb body 310. A plurality of movable blades 324 are provided within the housing 322 of the upper comb body 320.

Each movable blade 324 is positioned substantially above a corresponding folding region 319 of the lower comb body 310. The movable blades 324 are adapted to be moved vertically together or preferably independent of each other. Thus, each movable blade 324 may be independently controlled by a central controller, for example. The movement of the movable blades 324 may be achieved in numerous ways apparent to those skilled in the art. For example, the movement of the movable blades 324 may be facilitated by a motor adapted to translate each blade along a track formed at one end of the housing 322 for each track (not shown). In alternative embodiment the housing 322 may include an upper comb plate 326 that moves to force the blades into the airbag 110 and cavity 113. The upper comb plates 326 may be configured to provide sequential folding of the airbag 110.

FIG. 4 illustrates the use of the arrangement 300 of FIG. 3 for folding the airbag cushion 110. With one end of the airbag 110 secured with the clamp 316, the movable blade 324a closest to the fixed end of the airbag 110 is translated downward. The downward movement of the movable blade 324a extends the movable blade 324a into the corresponding folding region 319a between one side of the housing 312 and a fixed blade 318a of the lower comb body 310. A fold of the airbag 110 is thus created within the folding region 319a corresponding to the movable blade 324a.

The creation of a fold naturally causes the airbag 110 to move toward the fold. Since one end of the airbag 110 is secured by the clamp 316, the free end (not shown) of the airbag 110 moves toward the fold. Downward movement of other movable blades 324 of the upper comb body 320 in a sequential manner creates additional folds in each folding region 319 of the lower comb body 310. The sequential manner proceeds from the movable blades 324 closest to the fixed end of the airbag 110 to those furthest from it.

It is noted that, to prevent unfolding of folds, a movable blade 324 that has been moved downward to create a fold should remain in its lowered position at least until the next fold is created. For example, the first movable blade 324a should remain in the lowered position at least until the second movable blade 324b is moved into its lowered position. Otherwise, the downward movement of the second blade 324b may cause an unfolding of the fold created in the first folding region 319a by the first movable blade 324a.

In the embodiment illustrated in FIG. 4, the first movable blade 324a is completely in its lowered position, while the second movable blade 324b has remained in its fully raised position. It will be understood by those skilled in the art that, in order to enhance the speed of the folding process, the movement of the subsequent blades may be initiated before the completion of the movement of the earlier blades. Thus, the second movable blade 324b may be on its way to the lowered position before the first movable blade 324a has completed its translation. Furthermore, the earlier moving blades may remain lowered until all blades have been lowered. In an alternative embodiment, at least the adjacent blade remains lowered while the next blade creates a fold in the bag. Either of the aforementioned arrangements ensures that earlier created folds are not disturbed by later moving blades.

The exemplary embodiment illustrated in FIGS. 3 and 4 is provided with seven folding regions 319. Of course, those skilled in the art will understand that other arrangements may be provided with any desired number of folding regions 319. Further, in one embodiment, the lower comb body 310 may be provided with a larger number of folding regions 319, while the upper comb body 320 may be provided with a smaller number of movable blades 324. In this regard, the upper comb body 320 and the lower comb body 310 may be adapted to translate relative to each other to align the movable blades 324 with different folding regions 319.

As described above, the various embodiments of the present invention, provide several advantages such as, for example, a one-time “push in” folding operation. For example, a single translation of the scoop or upper comb plate will yield a folded airbag. Thus, the present invention provides for a short lead time, comfortable, efficient folding process. The embodiments of the present invention may be tailored or modified to produce different folding patterns as required for different modules or vehicles.

Given the disclosure of the present invention, one versed in the art would appreciate that there may be other embodiments and modifications within the scope and spirit of the invention. Accordingly, all modifications attainable by one versed in the art from the present disclosure within the scope and spirit of the present invention are to be included as further embodiments of the present invention. The scope of the present invention is to be defined as set forth in the following claims.

What is claimed is:

1. An airbag folding body, comprising:
a cavity having a rear wall and a top wall, the rear wall located opposing an entrance for an airbag; and
a notch formed at an intersection of the top wall and the rear wall, the notch being adapted to capture, engage or secure a leading edge of the airbag;
wherein the rear wall is adapted to direct the leading edge of the airbag toward the notch.

2. The airbag folding body of claim 1, wherein the cavity is adapted to accommodate the airbag in a folded configuration.

3. The airbag folding body of claim 1, further comprising a bottom wall, wherein the transition between the rear wall and the bottom wall is rounded to direct the leading edge of the airbag toward the notch.

4. The airbag folding body of claim 1, further comprising:
a bottom wall connected to the rear wall, the bottom wall having a ramp adapted to guide the airbag into the cavity.

5. A method of folding an airbag, comprising:
causing relative movement of an airbag toward a folding body, the folding body having a cavity with a rear wall and a top wall; and
directing a leading edge of the airbag toward a notch formed at an intersection of the top wall and the rear wall of the folding body, the notch being adapted to capture, engage or secure the leading edge.

6. The method of claim 5, wherein the cavity is adapted to accommodate the airbag cushion in a folded configuration.

7. The airbag folding body of claim 5, wherein the step of directing includes using a rounded transition provided on the rear wall.

8. An airbag folding arrangement, comprising:
a first comb portion comprising:
two or more folding regions, the folding regions being separated by stationary blades; and
a fastener for securing an end of an airbag cushion; and
a second comb portion having one or more movable blades adapted to translate at least partially into the folding regions, thereby forming a fold of an airbag cushion positioned between the first comb portion and the second comb portion.

9. The arrangement of claim 8, wherein the second comb portion includes a movable plate configured to push the movable blades into the folding regions.

10. An airbag folding method, comprising:
positioning an airbag between a first comb portion and a second comb portion, the first comb portion having two or more folding regions, the folding regions being separated by stationary blades, the second comb portion having one or more movable blades positioned above corresponding folding regions and being adapted to translate at least partially into the folding regions;
securing one end of the airbag on one side of the folding regions;
translating the movable blades sequentially into the folding regions proceeding from a folding region closest to the secured end of the airbag to a folding region further from the secured end of the airbag.
